(19) United States
(12) Patent Application Publication
(10) Pub. No.: US 2016/0196555 A1
(43) Pub. Date: Jul. 7, 2016

(54) ELECTRONIC PLATFORM FOR SUPPORTING TRANSACTION TRANSMISSION MODIFICATION CAPABILITIES FOR VARIOUS LEVELS OF ENTITLEMENT

(71) Applicant: Bank of America Corporation, Charlotte, NC (US)

(72) Inventors: Patricia Rudek, Rochester, NY (US); Michelle D. Nichols, Rock Hill, SC (US)

(21) Appl. No.: 14/588,438

(22) Filed: Jan. 1, 2015

(51) Int. Cl. G06Q 20/40; G06Q 20/38

(52) U.S. Cl. CPC G06Q 20/40; G06Q 20/382

(57) ABSTRACT

An apparatus for providing a transmission tracking system is provided. The apparatus may display a hierarchal view of a transmission associated with a transaction. The apparatus may sort the transmission among a plurality of transmissions. The sorted transmissions may be displayed in the hierarchal view on the display. The system may further display the status of the transmissions. Displaying the status may include displaying the location of the transmission within the transmission lifecycle. The transmission lifecycle may include transmission origination; intermediate status of the transmission; and completion status of the transmission. The system may also transmit a permission to modify the transmission. The permission may be provided preferably only if a user possesses a valid entitlement. The valid entitlement may be an entitlement to modify the transmission and may depend on the location of the transmission within the transmission lifecycle and an entitlement of the user.

### FIELD OF TECHNOLOGY

This application relates to transaction transmission modification.

### BACKGROUND OF THE DISCLOSURE

Within any financial institution, transaction transmission occurs. Furthermore transaction transmission modification occurs. For example, a payment may be executed on behalf of the financial institution. The payment may be transmitted to the payee. During the pendency of such a transaction transmission, the transaction transmission may be modified in response to input from authorized individuals.

However, such input may be limited to certain authorized individuals within the financial institution. Such input may not be valid if received from individuals within the financial institution other than the authorized individuals.

At certain stages of certain transactions, certain individuals may be authorized to contribute input to the transaction. At other stages of the transaction, other individuals, which may or may not include the first individuals, may be authorized to contribute input to the transaction. In certain circumstances, certain groups of individuals may be authorized to contribute input to the transaction. At other stages of the transaction, other groups, which may or may not include the first groups, may be authorized to contribute input to the transaction.

It would be desirable to display hierarchical maps for adjustment and/or modification to illustrate transaction modification entitlements by one or more users.

It would be yet more desirable to determine whether actions taken may be processed using Straight Through Processing, preferably independent of additional human intervention.

### SUMMARY OF THE INVENTION

A centralized transmission tracking system is provided. A method for implementing such a system may include providing, on a hierarchal display, a view of a transmission associated with a transaction. The method may also include sorting, within the hierarchal display, the transmission associated with the transaction. Before, during or after the sorting, the method may include displaying the status of the transmission. The displaying the status may include displaying the location of the transmission within a transmission lifecycle. The transmission lifecycle may include transmission origination. The transmission lifecycle may include intermediate status of the transmission. The transmission lifecycle may also include completion status of the transmission. Preferably, the method may also include providing, to a user, a capability to modify the transmission. The capability may preferably be provided only if the user possesses valid entitlement to modify the transmission. The entitlement may be dependent on the location of the transmission within the transmission lifecycle. The entitlement may also be dependent on an entitlement level of the user. The entitlement level may be based, at least in part, on a predetermined level of authority for the user.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with the principles of the invention;

FIG. 3 shows an illustrative flow diagram according to certain embodiments;

FIG. 4 shows another illustrative flow diagram in accordance with the principles of the invention;

FIG. 5 shows yet another illustrative flow diagram in accordance with the principles of the invention; and

FIG. 6 shows still another illustrative flow diagram in accordance with principles of the invention.

### DETAILED DESCRIPTION OF THE DISCLOSURE

Apparatus, methods and media (collectively referred to herein as a “system”) for providing a centralized transmission tracking system are provided.

For the sake of illustration, the invention will be described as being performed by a “system.” The “system” may include one or more of the features of the apparatus and methods that are shown or described herein and/or any other suitable device or approach. The “system” may be provided by an entity. The entity may be an individual, an organization or any other suitable entity.

The system may include a display. The display may be a hierarchal display. The system may provide a view on the display. The view may be a view of a transmission. The transmission may be associated with a transaction.

The system may sort one or more transmissions. The transmissions may include transmissions associated with the transaction. The transmission may be sorted within the hierarchal display.

The system may display a status. The status may include the status of the transmission. The displaying may include displaying a location. The location may be the location of the transmission. The location may include the location of the transmission within a transmission lifecycle.

The transmission lifecycle may include one or more points. The transmission lifecycle may include an origination. The origination may be a point of origination. The origination may be a point of transmission origination.

The transmission lifecycle may include an intermediate point. The intermediate point may be an intermediate point of the transmission. The transmission lifecycle may include an intermediate status associated with the intermediate point of the transmission.

The transmission lifecycle may include a completion point. The completion point may be the completion point of the transmission. The transmission lifecycle may include a completion status associated with the completion point of the transmission.

The system may provide a capability. The capability may be provided to a user. The capability may include capability to modify the transmission. The capability may be provided only if the user possess an entitlement. The entitlement may be a valid entitlement. The entitlement may be an entitlement to modify the transmission.

The entitlement may depend upon the location of the transmission within the transmission lifecycle. The entitlement may be dependent upon an entitlement level. The entitlement level may be an entitlement level of the user. The entitlement level may be based on a level of authority. The level of authority may be a predetermined level of authority. The entitlement level may be based in part on the level of authority. The level of authority may be the level of authority for the user.

The system may determine valid entitlement. Valid entitlement may be determined by determining a level. The level may be a first level. The level may be an entitlement level. The entitlement level may be a first entitlement level. The level may be an entitlement level of the user.

Valid entitlement may be determined by determining a location. The location may include the location of the transmission. The location may include the location of the transmission within the transmission lifecycle.

Valid entitlement may be determined by determining a required entitlement level. The required entitlement level may be the level required to modify the transmission. The level may be the level required to modify the transmission at a specified location. The location may be a position of the transmission within the transmission lifecycle.

Valid entitlement may be determined by determining if the first entitlement level provides sufficient entitlement. Sufficient entitlement may include sufficient entitlement to modify the transmission. The sufficient entitlement may include entitlement to modify the transmission at the current location. The location may include the location within the transmission lifecycle.

The modification may include cancelling the transmission. The transmission may be one of a plurality of transmissions.

The transmissions may be sorted by transmission characteristics. Exemplary transmission characteristics may include, but are not limited to, transaction destination, type of transaction, initiator of transaction, time of transaction, amount of transaction or any other suitable transmission characteristics.

Exemplary transmission types may include, but are not limited to, a check, money order, wire transfer, credit transaction, debit transaction, Automated Clearing House (“ACH”) transfer, peer-to-peer transfer, bank-to-bank transfer or any other suitable transmission type.

The system may determine an entitlement for modifying the transmission. The system may determine an entitlement authorization of the user. The system may determine if the entitlement authorization of the user exceeds the entitlement level. The entitlement level may be the entitlement level for modifying the transmission.

The system may determine that the location of the transmission within the transmission lifecycle is sufficient. The system may determine that the entitlement level of the user is sufficient.

Upon determining that the location of the transmission within the transmission lifecycle and the entitlement level of the user are sufficient, the system may modify, in response to the sufficiently entitled user's instruction, the transmission. The transmission may be modified using Straight Through Processing. The modification using Straight Through Processing may be modified without additional human intervention. That is to say that, upon receiving an instruction from the sufficiently entitled user, the system may modify the transaction. Such modifications may include, for example, cancelling the transaction, increasing the value of the transaction, decreasing the value of the transaction, changing the timing of the transaction, changing one or more parties associated with the transaction (such as a designated payor or payee associated with the transaction) or any other suitable aspect of the transaction.

The system may determine that at least one of: the location of the transmission within the transmission lifecycle or the entitlement level of the user is insufficient. Upon determining that at least one of: the location of the transmission within the transmission lifecycle or the entitlement level of the user is insufficient, the system may initiate a review. The review may be a manual review. The review may be a review process. The review may be a review process for modification of the transmission.

The modification of the transmission may include editing the transmission.

The modification may include modifying characteristics of a subset of transactions. The characteristics may be modified simultaneously. The subset of transactions may be from a larger group of transactions.

The system may provide a view. The view may be a holistic view. The holistic view may be a view of a period of time. The period of time may be a predefined period of time. The view may include a view of all transmissions. The transmissions may each be related to transactions.

The view may include a visual display. The visual display may display one or more transmissions. The one or more transmissions may include transmissions in progress.

The display may display the location of each of the transmissions. The display may display the location of each of the transmissions within the transmission lifecycle.

The system may provide a hierarchal display. The hierarchal display may display a view. The view may include a view of a transmission. The transmission may be associated with a transaction.

The system may sort one or more of the transmissions. The one or more transmissions may be sorted within the hierarchal display.

The system may display the status of the transmission. The displaying of the status may include displaying the location of the transmission. The location of the transmission within the transmission lifecycle may be displayed.

The transmission lifecycle may include a transmission origination, intermediate status of the transmission and completion status of the transmission.

The system may provide a capability. The capability may be provided to a user. The capability may include the capability to modify the transmission (or the transaction, which may form the subject of the transmission).

The capability may preferably only be provided if the user possesses an entitlement. The entitlement may be a valid entitlement. The entitlement may include entitlement to modify the transmission.

The entitlement may be dependent on one or more factors. The one or more factors may include the location of the transmission within the transmission lifecycle.

The one or more factors may include an entitlement level of the user. The entitlement level may be based on a predetermined level of authority. The level of authority may be the level of authority of the user.

The system may determine valid entitlement by determining one or more factors. The one or more factors may include determining a first entitlement level. The first entitlement level may be the entitlement level of the user.

The one or more factors may include determining the location of the transmission within the transmission lifecycle, determining an entitlement level required to modify the transmission at the location within the transmission lifecycle and/or determining if the first entitlement level of the user provides sufficient entitlement. The sufficient entitlement may include entitlement to modify the transmission. The entitlement may include entitlement to modify the transmission at the current location within the transmission lifecycle.

The modification may include cancelling the transmission. The modification may include editing the transmission.

The system may determine an entitlement level for modifying the transmission. The system may determine the entitlement authorization of the user. The system may determine if the entitlement authorization of the user meets and/or exceeds the entitlement level for modifying the transmission.

The system may determine that the location of the transmission within the transmission lifecycle is sufficient. The system may determine that the entitlement level of the user is sufficient. The system may determine that both the location of the transmission and the entitlement level of the user are sufficient. Upon determining that one or both of the location of the transmission and the entitlement level of the user are sufficient, the system may modify the transaction. The transaction may be modified using Straight Through Processing.

The system may determine that the location of the transmission within the transmission lifecycle is insufficient. The system may determine that the entitlement level of the user is insufficient. Upon determining that one or both of the location of the transmission within the transmission lifecycle, and the entitlement of the user, are insufficient, the system may initiate a manual review process. The manual review process may review modification of the transmission.

The transmission may be one of a plurality of transmissions. When the transmission is one of a plurality of transmissions, the system may provide a holistic view. The holistic view may be provided within a predefined period of time. The holistic view may include a view of all transmissions.

The holistic view may include a visual display of each of the transmissions in progress. The holistic view may include the location of each of the transmissions within the transmission lifecycle. The holistic view, as presented to an individual user, may preferably visually indicate whether the user qualifies as entitled. Such visual indication may show a list of transmissions, and indicate in a visually indication that causes the transmission to stand out from the rest of the list.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

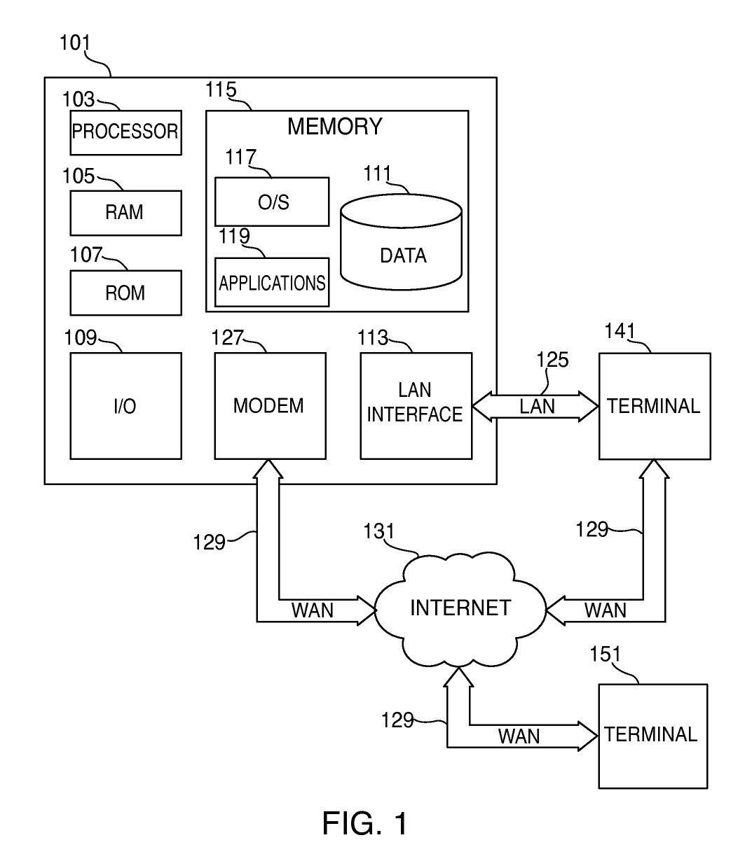

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information. Terminals 151 and/or terminal 141 may be other devices. These devices may be identical to system 100 or different. The differences may be related to hardware components and/or software components.

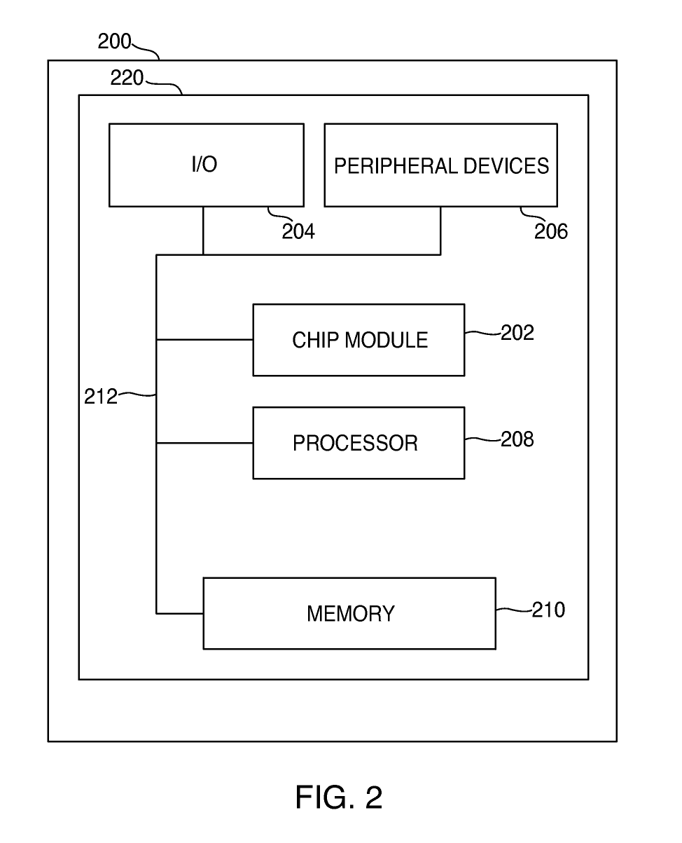

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data and/or determine entitlement requirements and machine-readable memory 210.

Machine-readable memory 210 may be configured to store in machine-readable data structures: information pertaining to a signatory, information pertaining to an administrator of the repository and the signatories which he may oversee, the current time, information pertaining to historical entitlements, information relating to current transmissions, current transactions and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

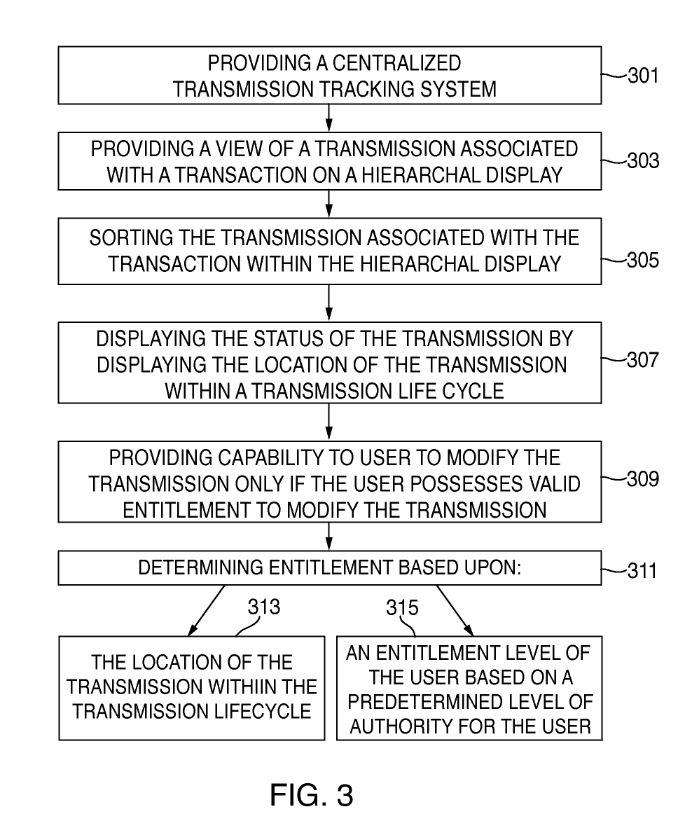

FIG. 3 shows illustrative process 301 for providing a centralized transmission tracking system.

Process 301 may begin at step 303. At step 303, the system may provide a view. The view may include the view of a transmission. The transmission may be associated with a transaction. The view may be displayed on a hierarchal display.

At step 305, the system may sort the transmission associated with the transaction. The transmission may be sorted within the hierarchal display.

At step 307, the system may display the status of the transmission. The status may be displayed by displaying the location of the transmission. The location of the transmission may include the location of the transmission within the transmission lifecycle.

At step 309, the system may provide capability to the user. The capability may include capability to modify the transmission. The transmission may be modified only if the user possesses valid entitlement. Valid entitlement may include entitlement to modify the transmission.

At step 311, the system may determine entitlement.

At step 313, the system may determine entitlement based upon the location of the transmission within the transmission lifecycle.

At step 315, the system may determine an entitlement level of the user. The entitlement level may be determined based on a level of authority. The level of authority may be a predetermined level of authority for the user.

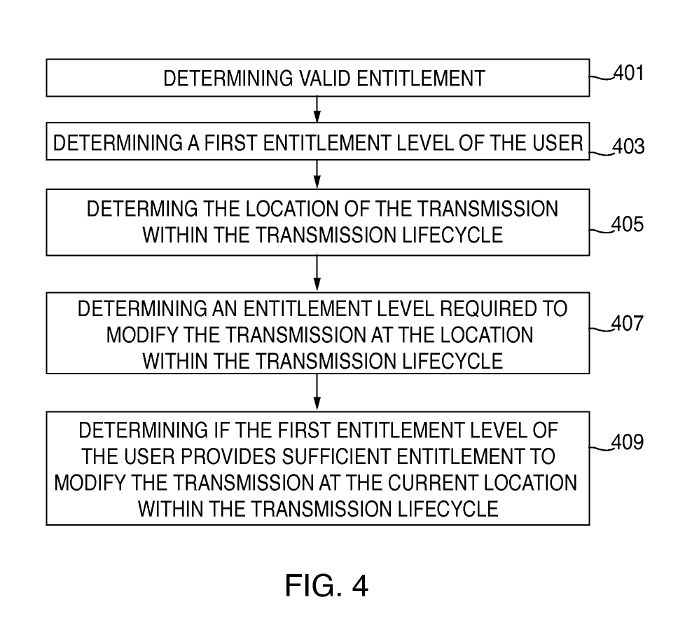

FIG. 4 shows illustrative process 401 for determining valid entitlement.

Process 401 may begin at step 403. At step 403, the system may determine a level. The level may be an entitlement level of a user. The entitlement level may be a first entitlement level.

At step 405, the system may determine a location. The location may be the location of a transmission. The transmission may be located within a transmission lifecycle.

At step 407, the system may determine an entitlement level. The entitlement level may be a level required to modify the transmission. The level may be the entitlement level required to modify the transmission at a given location within the transmission lifecycle.

At step 409, the system may determine if the first entitlement level of the user provides sufficient entitlement. The entitlement may include entitlement to modify the transmission. The transmission may be modified at the current location within the transmission lifecycle.

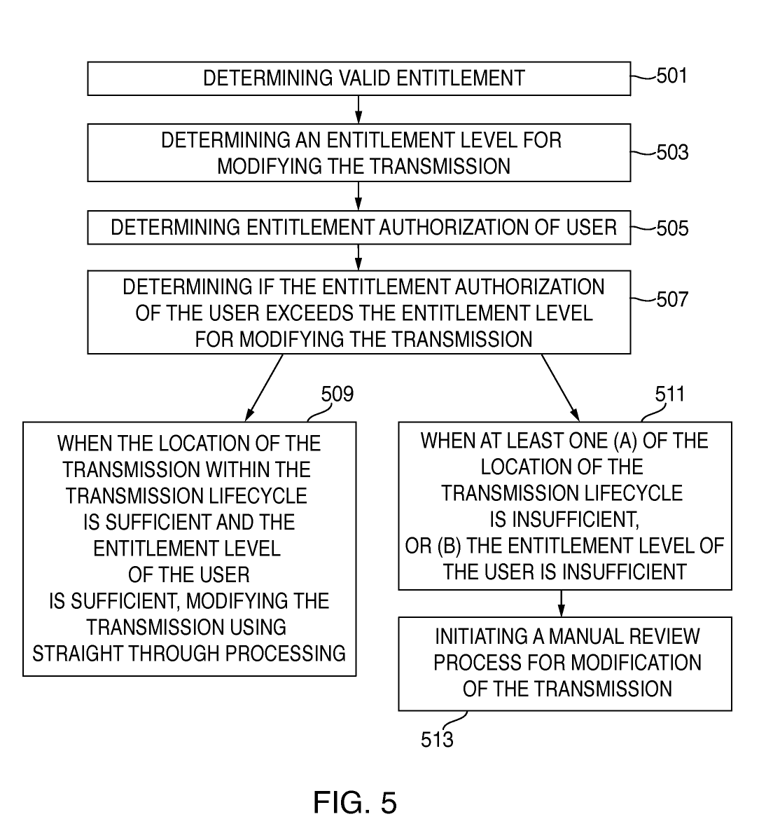

FIG. 5 shows illustrative process 501 for determining valid entitlement.

Process 501 may begin at step 503. At step 503, the system may determine an entitlement level. The entitlement level may be the entitlement level required for modifying a transmission.

At step 505, the system may determine entitlement authorization. The entitlement authorization may be the entitlement authorization of a user.

At step 507, the system may determine if the entitlement authorization of the user exceeds the entitlement level for modifying the transmission.

After step 507, the system may proceed to step 509. Alternatively, after step 507, the system may proceed to step 511.

At step 509, the system may determine that the location of the transmission within the transmission lifecycle is sufficient. The system may determine that the entitlement level of the user is sufficient. Upon determining that one or both of the location of the transmission within the transmission lifecycle, and the entitlement level of the user, are sufficient, the system may modify the transmission. The transmission may be modified using straight through processing.

At step 511, the system may determine that the location of the transmission within the transmission lifecycle is insufficient. The system may determine that the entitlement level of the user is insufficient.

At step 513, the system may initiate a review. The review may be a manual review. The review may be a review process modification of the transmission.

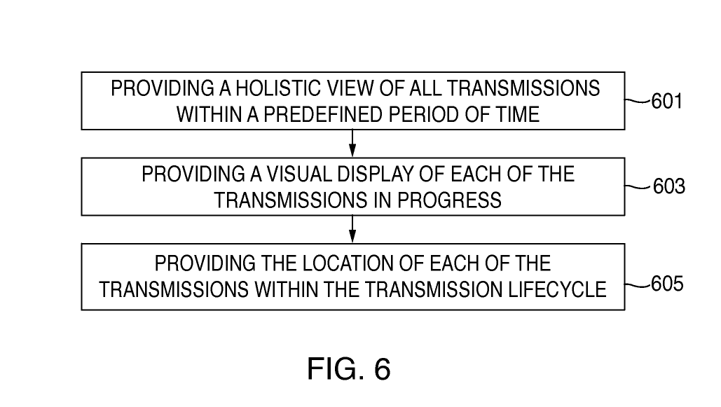

FIG. 6 shows illustrative process 601 for providing a holistic view of all transmissions within a predefined period of time.

Process 601 may begin at step 603. At step 603, the system may provide a display. The display may be a visual display. The display may be a display of each of the transmissions in progress.

At step 605, the system may provide a location. The location may be the location of each of the transmissions within the transmission lifecycle.

Thus, methods and apparatus for displaying an interactive hierarchical entitlement map, and electronic platform that enables user modification of the map, are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for providing a centralized transmission tracking system, the method comprising:
providing, on a hierarchal display, a view of a transmission associated with a transaction;
sorting, within the hierarchal display, the transmission associated with the transaction;
displaying the status of the transmission, wherein the displaying the status comprises displaying, for the transmission, the location of the transmission within a transmission lifecycle, said transmission lifecycle comprising:
transmission origination;
intermediate status of the transmission; and
completion status of the transmission; and
providing, to a user, capability to modify the transmission, wherein the capability is provided only if the user possesses valid entitlement to modify the transmission, said entitlement being dependent on:
the location of the transmission within the transmission lifecycle; and
an entitlement level of the user, wherein the entitlement level is based, at least in part, on a predetermined level of authority for the user.

2. The method of claim 1 wherein valid entitlement is determined by:
determining a first entitlement level of the user;
determining the location of the transmission within the transmission lifecycle;
determining an entitlement level required to modify the transmission at the location within the transmission lifecycle; and
determining if the first entitlement level of the user provides sufficient entitlement to modify the transmission at the current location within the transmission lifecycle.

3. The method of claim 1 wherein the modification comprises cancelling the transmission.

4. The method of claim 1 wherein the transmission is one of a plurality of transmissions.

5. The method of claim 1 wherein the transmissions are sorted by transmission characteristics, said transmission characteristics being selected from the group consisting of:
transaction destination;
type of transaction;
initiator of transaction;
time of transaction; and
amount of transaction.

6. The method of claim 1 wherein the transmission type is selected from the group consisting of:
a check;
a wire transfer;
a credit transaction;
a debit transaction;
an Automated Clearing House (“ACH”) transfer; and
a bank-to-bank transfer.

7. The method of claim 1 wherein the method further comprises:
determining an entitlement level for modifying the transmission;
determining entitlement authorization of the user; and
determining if the entitlement authorization of the user exceeds the entitlement level for modifying the transmission.

8. The method of claim 1 wherein, when the location of the transmission within the transmission lifecycle is sufficient and the entitlement level of the user is sufficient, the method further comprises modifying the transmission using Straight Through Processing.

9. The method of claim 1 wherein, when at least one of the location of the transmission within the transmission lifecycle is insufficient, or the entitlement level of the user is insufficient, the method further comprises initiating a manual review process for modification of the transmission.

10. The method of claim 1 wherein the modification comprises editing the transmission.

11. The method of claim 1 wherein the modification comprises modifying, simultaneously, characteristics of a subset of transactions from a larger transaction.

12. The method of claim 1 further comprising providing a holistic view, within a predefined period of time, of all transmissions, wherein the holistic view comprises:
a visual display of each of the transmissions in progress; and
the location of each of the transmissions within the transmission lifecycle.

13. A method for providing a centralized transmission tracking system, the method comprising:
providing, on a hierarchal display, a view of a transmission associated with a transaction;
sorting, within the hierarchal display, the transmission;
displaying the status of the transmission, wherein the displaying the status comprises displaying, for the transmission, the location of the transmission within the transmission lifecycle, said transmission lifecycle comprising:
transmission origination;
intermediate status of the transmission; and
completion status of the transmission; and
providing, to a user, capability to modify the transmission, wherein the capability is provided only if the user possesses valid entitlement to modify the transmission, said entitlement being dependent on:
the location of the transmission within the transmission lifecycle; and
an entitlement level of the user, wherein the entitlement level is based, at least in part, on a predetermined level of authority of the user.

14. The method of claim 13 wherein valid entitlement is determined by:
determining a first entitlement level of the user;
determining the location of the transmission within the transmission lifecycle;
determining an entitlement level required to modify the transmission at the location within the transmission lifecycle; and
determining if the first entitlement level of the user provides sufficient entitlement to modify the transmission at the current location within the transmission lifecycle.

15. The method of claim 13 wherein the modification comprises cancelling the transmission.

16. The method of claim 13 wherein the method further comprises:
determining an entitlement level for modifying the transmission;
determining entitlement authorization of the user; and
determining if the entitlement authorization of the user exceeds the entitlement level for modifying the transmission.

17. The method of claim 13 wherein, when the location of the transmission within the transmission lifecycle is sufficient and the entitlement level of the user is sufficient, the method further comprises modifying the transaction using Straight Through Processing.

18. The method of claim 13 wherein, when at least one of the location of the transmission within the transmission lifecycle is insufficient, or the entitlement level of the user is insufficient, the method further comprises initiating a manual review process for modification of the transmission.

19. The method of claim 13 wherein the modification comprises editing the transmission.

20. The method of claim 13 wherein the transmission is one of a plurality of transmissions, the method further comprises providing a holistic view, within a predefined period of time, of all transmissions, wherein the holistic view comprises:
a visual display of each of the transmissions in progress; and
the location of each of the transmissions within the transmission lifecycle.

21. An apparatus for providing a centralized transmission tracking system, the apparatus comprising:
a display configured to display, a hierarchal view of a transmission associated with a transaction;
a processor configured to sort the transmission among a plurality of transmissions, wherein the sorted transmissions are displayed in the hierarchal view on the display;
the display further configured to display the status of the transmissions, wherein the displaying the status comprises displaying, for the transmission, the location of the transmission within the transmission lifecycle, said transmission lifecycle comprising:
transmission origination;
intermediate status of the transmission; and
completion status of the transmission; and
a transmitter configured to transmit, to a user, a permission to modify the transmission, wherein the permission is provided only if the user possesses a valid entitlement, said entitlement being an entitlement to modify the transmission, said entitlement being dependent on:
the location of the transmission within the transmission lifecycle; and
an entitlement level of the user, wherein the entitlement level is based, at least in part, on a predetermined level of authority for a user.

22. The apparatus of claim 21 wherein the processor is further configured to determine valid entitlement by:
determining a first entitlement level of the user;
determining the location of the transmission within the transmission lifecycle;
determining an entitlement level required to modify the transmission at the location within the transmission lifecycle; and
determining if the first entitlement level of the user provides sufficient entitlement to modify the transmission at the current location within the transmission lifecycle.

23. The apparatus of claim 21 wherein the processor is further configured to:
determine an entitlement level for modifying the transmission;
determine entitlement authorization of the user; and
determine if the entitlement authorization of the user exceeds the entitlement level for modifying the transmission.
